(19) United States
(12) Patent Application Publication
(10) Pub. No.: US 2007/0226388 A1
(43) Pub. Date: Sep. 27, 2007

(54) System for detecting USB device

(75) Inventor: Kuo-Chang Lin, Taipei City (TW)

Correspondence Address: THE LAW OFFICES OF ANDREW D. FORTNEY, PH.D., P.C., 401 W FALLBROOK AVE STE 204, FRESNO, CA, 93711-5835, US

(73) Assignee: Quanta Computer Inc.

(21) Appl. No.: 11/595,712

(22) Filed: Nov. 10, 2006

(30) Foreign Application Priority Data
Mar. 22, 2006 (TW) 095109750

(51) Int. Cl. G06F 3/00; G06F 13/00

(52) U.S. Cl. 710/104; 710/10

(57) ABSTRACT

The invention discloses a system for detecting a USB device installed on a computer system. The computer system includes a host and a power supply. The detecting system includes a USB connector and a delay circuit. The USB device is connected to the USB connector. The USB connector has at least one data bus. The delay circuit is coupled to the at least one data bus and used for controlling the at least one data bus to be turned on/off. When the computer system is started, the power supply supplies power to the delay circuit. After a predetermined delay time, the delay circuit controls the at least one data bus to be turned on, and then the host of the computer system can detect the USB device via the at least one data bus.

### BACKGROUND OF THE INVENTION

1. Field of the Invention

The invention relates to a system for detecting a USB device and, more particularly, to a system capable of accurately detecting a built-in or external USB device installed in a computer system.

2. Description of the Prior Art

Recently, universal serial bus (USB) is broadly and popularly applied to computer system. In general, some computer systems with USB interface usually include not only a host and a power supply but also at least one USB connector for connecting with a built-in or external USB device. When the computer system is started, the host may not detect the USB device since it is not ready. If the USB device is an external USB device, the user has to reinsert the USB device to the USB connector till the host detects the USB device. However, if the USB device is a built-in USB device, since the user cannot reinsert the USB device into the USB connector, it often troubles the user.

Referring to FIGS. 1 and 2, FIG. 1 is a schematic diagram illustrating the circuit of a bus switch 1 of the prior art; and FIG. 2 is a schematic diagram illustrating the circuit of a USB device 2 of the prior art. Generally speaking, there are two methods capable of solving the aforesaid problems. As shown in FIG. 1, designers may install the bus switch 1 in a computer system (not shown). When the host of the computer system is ready, it is controlled by a software program to output an enabling signal to activate the data bus USB DATA+ or USB DATA− on, such that the host can accurately detect the USB device (not shown). However, the bus switch 1 will raise the cost of the computer system, and it needs some additional programs.

As shown in FIG. 2, designers can also install a resistor 20 and a capacitor 22 in the USB device 2 to control the reset timing when the host (not shown) starts to detect the USB device 2. However, since most of the USB devices are module type, the reset timing of those USB devices cannot be adjusted by designers at will. Also, once the original sequence of the USB device is changed, it may cause other side effects.

Therefore, the scope of the invention is to provide a system for detecting a USB device to solve the aforementioned problems.

### SUMMARY OF THE INVENTION

A scope of the invention is to provide a USB device detecting system utilizing a delay circuit for accurately detecting a built-in or external USB device installed in a computer system.

According to a preferred embodiment, the system of the invention is used for detecting a USB device installed in a computer system. The computer system comprises a host and a power supply. The system comprises at least one USB connector and a delay circuit. The USB device is connected to one of the at least one USB connector. The USB connector has at least one data bus. The delay circuit is coupled to the data bus of the USB connector and used for controlling the switch of the data bus.

In this embodiment, when the computer system is started, the power supply supplies power to the delay circuit. After a predetermined delay time, the delay circuit controls the data bus to be turned on; thereby the host of the computer system is capable of detecting the USB device via the data bus.

Therefore, according to the system of the invention, when the computer system is started, the host will not detect the USB device at once. After the predetermined delay time, the host will be ready to detect the USB device, so as to avoid the problem that the host cannot detect the USB device.

The advantage and spirit of the invention may be understood by the following recitations together with the appended drawings.

### BRIEF DESCRIPTION OF THE APPENDED DRAWINGS

FIG. 1 is a schematic diagram illustrating the circuit of a bus switch of the prior art;

FIG. 2 is a schematic diagram illustrating the circuit of a USB device of the prior art;

FIG. 3 is a functional block diagram illustrating a computer system according to a preferred embodiment of the invention;

FIG. 4 is a schematic diagram illustrating the circuit of the USB connector shown in FIG. 3; and

FIG. 5 is a schematic diagram illustrating the delay circuit shown in FIG. 3.

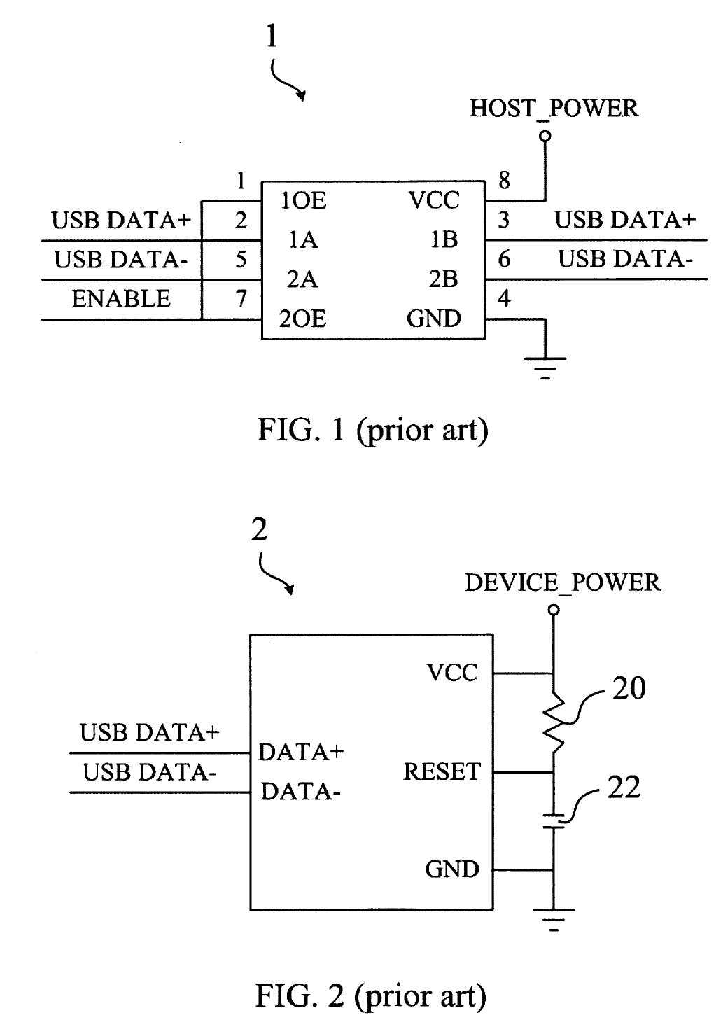

### DETAILED DESCRIPTION OF THE INVENTION

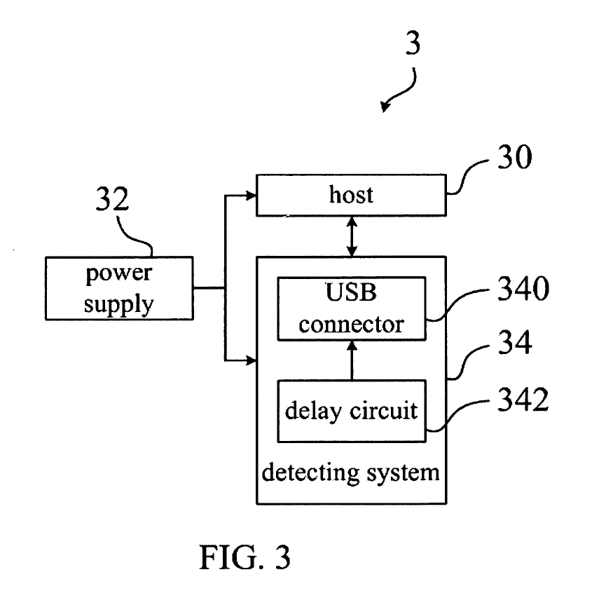

Referring to FIG. 3, FIG. 3 is a functional block diagram illustrating a computer system 3 according to a preferred embodiment of the invention. In this embodiment, the computer system 3 comprises a host 30, a power supply 32, and a detecting system 34. The detecting system 34 is used for detecting a USB device (not shown) installed in the computer system 3. The detecting system 34 of the invention is adaptive to detect a built-in or external USB device. The detecting system 34 comprises at least one USB connector 340 and a delay circuit 342. In FIG. 3, only one USB connector 340 is shown for description, but the invention is not limited to this USB connector 340.

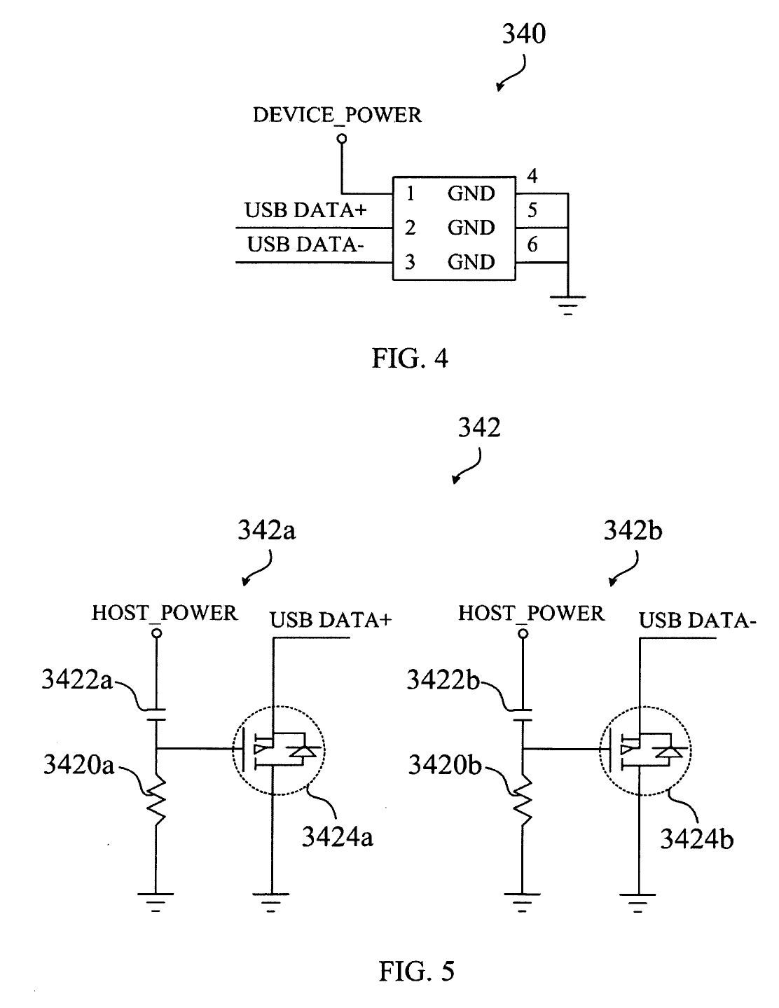

Referring to FIG. 4, FIG. 4 is a schematic diagram illustrating the circuit of the USB connector 340 shown in FIG. 3. The USB connector 340 has two data bus USB DATA+ and USB DATA−, as shown in FIG. 4. In this embodiment, the USB device (not shown) is connected to the USB connector 340.

Referring to FIG. 5, FIG. 5 is a schematic diagram illustrating the delay circuit 342 shown in FIG. 3. The delay circuit 342 comprises two circuits 342a and 342b, as shown in FIG. 5. The circuit 342a comprises a resistor 3420a, a capacitor 3422a, and a metal oxide semiconductor field effect transistor (MOSFET) 3424a, and the circuit 342b comprises a resistor 3420b, a capacitor 3422b, and a MOSFET 3424b.

In this embodiment, when the computer system 3 is started, the power supply 32 supplies power to the host 30 and the delay circuit 342 of the detecting system 34. After a predetermined delay time, when the host 30 is ready, the MOSFET 3424a of the circuit 342a will be enabled by voltage to control the data bus USB DATA+ to be turned on, and the MOSFET 3424b of the circuit 342b will be also enabled by voltage to control the data bus USB DATA− to be turned on; thereby the host 30 of the computer system 3 is capable of detecting the USB device (not shown) connected to the USB connector 340 via the data bus USB DATA+ or USB DATA−. In this embodiment, the predetermined delay time can be adjusted by the resistors 3420a and 3420b and the capacitors 3422a and 3422b. Preferably, if the predetermined delay time is set as 500 ms, all types of USB devices can be detected accurately after the host 30 is started.

In another preferred embodiment, the MOSFET 3424a of the circuit 342a and the MOSFET 3424b of the circuit 342b can be designed as the same MOSFET. In other words, the invention can utilize just one MOSFET to control the data bus USB DATA+ or USB DATA− to be turned on/off.

Compared to the prior art, according to the system of the invention, when the computer system is started, the host will not detect the USB device at once. After the predetermined delay time, the host will be ready to detect the USB device, so as to avoid the problem that the host cannot detect the USB device. Furthermore, since the delay circuit of the invention consists of resistor, capacitor, and MOSFET, not only circuit design is simpler but the cost is lower.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A system for detecting a universal serial bus (USB) device installed on a computer system, the computer system comprising a host and a power supply, the system comprising:
at least one USB connector having at least one data bus, the USB device being connected to one of the at least one USB connector; and
a delay circuit, coupled to the at least one data bus of the USB connector, for controlling the at least one data bus to be turned on/off,
wherein when the computer system is started, the power supply supplies power to the delay circuit, and after a predetermined delay time, the delay circuit controls the at least one data bus to be turned on; thereby, the host of the computer system is capable of detecting the USB device via the at least one data bus.

2. The system of claim 1, wherein the delay circuit comprises at least one resistor, at least one capacitor, and at least one transistor, the at least one resistor and the at least one capacitor are used for modulating the predetermined delay time, and the at least one transistor is used for controlling the at least one data bus to be turned on/off.

3. The system of claim 1, wherein the USB device is a built-in USB device.

4. The system of claim 1, wherein the USB device is an external USB device.
